(19) United States
(12) Patent Application Publication
(10) Pub. No.: US 2016/0110859 A1
(43) Pub. Date: Apr. 21, 2016

(54) INSPECTION METHOD FOR CONTACT BY DIE TO DATABASE

(71) Applicant: MACRONIX International Co., Ltd., Hsinchu (TW)

(72) Inventors: Tuung Luoh, Hsinchu (TW); Hsiao-Leng Li, Hsinchu (TW); Ling-Wuu Yang, Hsinchu (TW); Ta-Hone Yang, Hsinchu (TW); Kuang-Chao Chen, Hsinchu (TW)

(21) Appl. No.: 14/516,961

(22) Filed: Oct. 17, 2014

(51) Int. Cl. G06T 7/00

(52) U.S. Cl. CPC G06T 7/0006; G06T 7/0008; G06T 7/001; G06T 2207/10061; G06T 2207/30148

(57) ABSTRACT

An inspection method for contact by die to database is provided. In the method, a plurality of raw images of contacts in a wafer is obtained, and a plurality of locations of the raw images is then recoded to obtain a graphic file. After that, the graphic file is aligned on a design database of the chip. An image extraction is then performed on the raw images to obtain a plurality of image contours of the contacts. Thereafter, a difference in critical dimension between the image contours of the contacts and corresponding contacts in the design database are measured in order to obtain the inspection result for contacts in the wafer.

### BACKGROUND OF THE INVENTION

1. Field of the Invention

The invention relates to a die inspection method, and particularly relates to an inspection method for contacts by die to database (D2DB).

2. Description of Related Art

As line widths continue to shrink in an IC manufacturing process, controlling and monitoring of critical dimensions in the manufacturing process become more and more important. In nanometer generation, it becomes more challenging to accurately inspect defects on a surface structure of a die.

Taking the inspection on contacts for example, there are two common methods. One of the methods is to inspect the contacts after photolithography and etching by using a focus-energy matrix (FEM) of different exposure energies and focuses, so as to define a FEM window. The other is to inspect the contacts by using an E-beam inspection tool.

However, since the FEM window does not mark a small contact, disconnection due to the small contact may not be detected. Therefore, the reliability of interconnections within a device is influenced. In addition, since the design targets (contact size) in whole chip are different, the difficulty in inspection further increases.

As for the E-beam inspection, it only detects a blind defect and mat be affected by the pre-layer in ILD/MLD (e.g., metal wiring). Besides, the E-beam inspection process requires obtaining the image of the whole chip to check the contacts one-by-one. Therefore, it usually takes several months to inspect a die. Therefore, the E-beam inspection is still insufficient in providing real-time results.

### SUMMARY OF THE INVENTION

The invention provides an inspection method for contacts by die to database (D2DB) capable of obtaining an inspection on the contacts accurately. In addition, the inspection on the contacts may be obtained both real-time and off-line.

The inspection method for the contacts by die to database includes obtaining raw images of the contacts in a wafer and decoding positions of the raw images to obtain a graphic file after decoding. Then, the graphic file is aligned on a design database of a chip, and an image extraction is performed on the raw images to obtain image contours of the contacts. Then, a difference in critical dimension (CD) between the image contours of the contacts and corresponding contacts in the design database is measured.

According to an embodiment of the invention, the contact further includes a via or a poly plug in the die.

According to an embodiment of the invention, the difference includes at least one of numerical differences in radius, size, and circular area of the contact.

According to an embodiment of the invention, the method further includes determining a defect type of the contact based on the difference, and the defect type includes a small contact, a bridge contact, or a blind contact.

According to an embodiment of the invention, before obtaining the raw images, the method further includes selecting a plurality of inspection areas that the contacts are located to be inspected in the wafer, and resetting coordinates of the inspection areas to minimize overlapped portions of the areas.

According to an embodiment of the invention, the method of selecting the inspection areas includes setting an area having a critical dimension (CD) lower than a predetermined value in the design database to be the inspection area.

According to an embodiment of the invention, the method of selecting the inspection areas includes setting an area having the contact with a size over or under a predetermined value to be the inspection area according to a design rule.

According to an embodiment of the invention, the method of selecting the inspection areas includes selecting the inspection areas according to a result of a wafer defect inspection previously performed.

According to an embodiment of the invention, the method of obtaining the raw images includes an E-beam inspection or E-beam SEM review tool (EBR).

According to each embodiment of the invention, an apparatus for executing the E-beam inspection includes an E-beam inspection tool, a bright field inspection equipment with a light source having a wavelength of 150 nm to 800 nm, a dark field inspection equipment with a laser light source, or a scanning electron microscope review tool.

According to an embodiment of the invention, the method of obtaining the raw images further includes decoding a metafile of the raw images and marking a position of the die and a defect coordinate position corresponding to a die corner, or transferring the raw images into the die database according to the connection between KLA Klarf file and the image.

According to an embodiment of the invention, the method of obtaining the raw images further includes decoding a filename of the raw images and marking a position of the die and a defect coordinate position corresponding to a die corner to transfer the raw images into the die database.

According to an embodiment of the invention, the method of obtaining the raw images includes only shooting according to a known die position and a defect coordinate position corresponding to a die corner to transfer the known die position and the corresponding image into the die database.

According to an embodiment of the invention, the design database includes a GDSII file of a source design database, a GDSII file of a simulated post-optical proximity correction, or a design database converted from a simulated tool.

According to an embodiment, the method of obtaining the raw images of the contacts includes obtaining the raw images of the contacts in selected regions in all dies or chips within whole wafer, or obtaining the raw images of the contacts in the selected regions in a portion of dies or chips within whole wafer.

According to an embodiment of the invention, a die register (i.e., align with some position in each die) may be performed to ensure the inspection apparatus is correctly aligned at each die of the wafer. Namely, each die is aligned to the same position (e.g., die corner). In addition, the same easy-to-identify position or a virtual die corner is set at to-be-shot positions or to-be-inspected coordinates (e.g., Klarf file) of different dies to improve alignment performance.

Based on the above, the invention is capable of obtaining the accurate contact defect information, such as the small contact, the bridge contact, or the blind contact in real-time or off-line by displaying the raw images of the contacts in the whole chip on the design database. Moreover, a more accurate result may be obtained by comparing the raw images with the design database by utilizing the image extraction. In addition, the invention is capable of quickly obtaining the defect information by directly comparing the raw images with the design database according to the physical coordinates. Even if the invention is to determine the optimum process conditions and scope of the focus-energy matrix (FEM) by D2DB of contacts, it is not limited herein. The inspection method of the invention may apply in FEM or process window qualification (PWQ) of a variety of different line width/space.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating an inspection method for contacts by die to database according to an embodiment of the invention.

FIG. 2 is a schematic view of a contact window obtained by current KLA inspection.

FIG. 3 is a schematic view of a contact window obtained by the inspection method in the embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

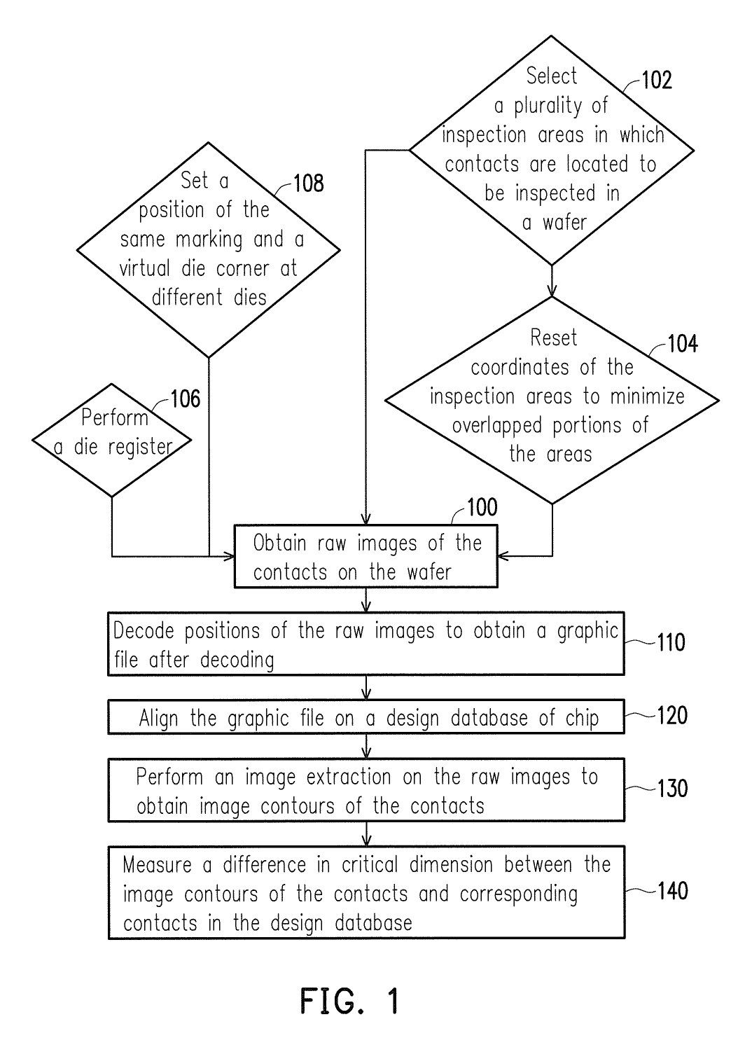

FIG. 1 is a flowchart illustrating an inspection method for contacts by die to database according to an embodiment of the invention.

Referring to FIG. 1, at Step 100, raw images of contacts in a wafer are obtained. A method of obtaining the raw image is an E-beam inspection or E-beam SEM review tool (EBR), for example. Although contacts are used as an example to describe this embodiment, the invention is not limited thereto. The method of the invention is generally applicable to parts/positions where the interconnection is desired in a semiconductor device. For example, the image inspection may be utilized on circular apertures or circles such as vias or poly plugs in a wafer or a variety of different line width/space to obtain the optimum process conditions and scope of the focus-energy matrix (FEM) or process window qualification (PWQ). In an embodiment, an apparatus for carrying out the E-beam inspection is an E-beam inspection tool, a bright field (BF) inspection equipment with a light source having a wavelength of 150 nm to 800 nm, a dark field (DF) inspection equipment with a laser light source, or a scanning electron microscope review tool. When outputting the raw images, a metafile of the raw images may be further decoded and marked with die positions and defect coordinate positions corresponding to a die corner to transfer the raw images into a die database. Moreover, the method of obtaining the raw images may further include decoding a filename of the raw images and marking the die positions and the defect coordinate positions corresponding to the die corner, or transferring the raw images into the die database according to the connection between KLA Klarf file and the raw images. In addition, the method of obtaining the raw images may further include only shooting according to known die positions and defect coordinate positions (e.g., Klarf file) corresponding to the die corner to transfer the known die positions and corresponding images into the die database.

In addition, before Step 100, a plurality of inspection areas in which the contacts are located to be inspected in the wafer may be selected (Step 102). Selecting the inspection areas at Step 102 is capable of significantly reducing the whole inspection process. In this embodiment, there are several methods for reducing the number of the inspection areas. For example, areas that undergo the following steps may be selected according to a result of a risk analysis, pattern density, design rule, minimum critical dimension (CD), pattern uniformity, or a result of an inspection using a KLA light field or dark field optical instrument. If necessary, the user may still choose to perform the following steps on all the contacts within the whole die.

Specifically, the method of selecting the inspection areas in this embodiment includes the following. First, an area having a CD lower than a predetermined value in a design database may be set as the inspection area. The design database includes, for example, a graphic data system (GDSII) file of a source database, a GDSII file of a simulated post-optical proximity correction (post-OPC), or a design database converted from a simulated tool. The so-called “GDSII” is one type of design database formats, and its file format is not limited to GDSII. That is, the design database format may be any format being capable of transferring out design files, such as Oasis or other database formats. Second, an area having a value over or under a predetermined value according to a design rule may be set as the inspection area. For example, a lithographic rule checking (LRC), a design rule checking (DRC), a care area may be directly implemented as a basis for selecting the inspection areas. Third, the inspection areas may be selected based on a result of a wafer defect inspection previously performed. The wafer defect inspection is, for example, a result of an inspection with a KLA instrument in a format known as KLARF (i.e., KLA Result File). In addition, the KLARF may be outputted based on multiple scanning with different light sources and resolutions, an optical scanning, or a single scanning with a single condition. The methods may be implemented by using one of the methods only or using two or more of the methods together. Moreover, the method of this embodiment still includes obtaining the raw images of the contacts in selected regions in all dies or chips within whole wafer. Furthermore, the method of this embodiment may include obtaining the raw images of the contacts in the selected regions in a portion of dies or chips within whole wafer.

For the selection of the care area, the inspection areas may be selected based on a risk analysis input (e.g., results of LRC, DRC, etc.), for example. Moreover, it is possible to select the inspection areas by a pattern search of a risk pattern specified or similarity. Furthermore, the inspection area may be selected by care area reduction or from KLA BF or DF.

In addition, after Step 102, the Step 100 may be directly performed or coordinates of the inspection areas may be reset to minimize overlapped portions of the areas (S104). For example, if the inspection areas are selected at Step 102 based on the result of the wafer defect inspection (e.g., KLA inspection), there may be portions where the inspection areas are overlapped with each other. If the same portion in the wafer is irradiated by the E-beam for multiple times, the wire architecture thereof may be damaged. Therefore, to prevent the inspection areas from overlapping each other, the overlapped portions of the overlapping inspection areas may be excluded through optimization computation based on the coordinates of the inspection areas, thereby resetting the inspection areas as inspection areas that do not overlap each other.

In addition, before Step 100, Step 106 may be performed to ensure the inspection apparatus is accurately aligned at each die of the wafer. At Step 106, a die register (i.e., aligning with some position in each die) is performed. Namely, each die is aligned to the same position (e.g., die corner). Alternatively, Step 108 that the same marking (e.g., an easy-to-identify position) or a virtual die corner is set at to-be-shot positions or to-be-inspected coordinates (e.g., Klarf file) of different dies may be performed to improve alignment performance.

After Step 100, Step 110 of decoding positions of the raw images is performed to obtain a decoded graphic file. Similar to Step 100, a result may be output from the E-beam inspection instrument for obtaining the raw images at Step 110. Namely, the decoding is performed after the LRC, care area, or risk area is inspected and shot by using the E-beam (Step 100).

Then, at Step 120, the graphic file and the design database of the dies are aligned. Namely, the positions inspected by the inspection equipment are transferred into a graphic file having GDS coordinates of the design database, and then are matched to a corresponding design layout in a scale of, for example, 1:1.

Then, at Step 130, image extraction is performed on the raw images to obtain image contours of the contacts. The image extraction is capable of extracting a two-dimensional (2D) image contour. A method of image extraction includes edge contour extraction, self-affine mapping system, self-affine snake model, active contour model, expectation-maximisation algorithm, principal component analysis; level sets algorithm, or Monte Carlo techniques, for example. The image extraction may be performed on-line to perform real-time processing through rapid computation and mark coordinates. In addition, the step is not limited on a single raw image. Instead, the image extraction may be performed on all of the raw images that are shot.

Then, at Step 140, a difference in CD between the image contours of the contacts and corresponding contacts in the design database is measured to obtain a result of contact defect inspection. In addition, based on the selected areas, a measurement may be performed once per unit, and the unit for the measurement may be selected from 0.0001 μm to 0.5 μm. The difference is, for example, at least one of numerical differences in radius, size, and circular area of the contacts. Moreover, after the difference is output, a defect type may be classified based on a degree of difference by setting a threshold condition. If a difference value is significantly greater than a standard target, a bridge contact may easily occur. However, if the difference value is significant smaller than the standard target (e.g., a small contact), an open circuit may easily occur. Lastly, a severity in classification and a result of a final defect analysis are output. A corresponding position of the defect may be found based on the die database coordinate system. Since the image contours may be displayed on a graph of the design database, a difference between the image contour and the design database may be compared in a real-time and accurate manner, thereby directly determining a defect type of the contact and classifying the defect in terms of degree of difference and severity. Besides, the embodiment is also capable of finding out repeated systematic defects or a hot spot based on inspection results of different dies in the wafer.

It should be noted that an algorithm that avoids error induced by a raw image interface is excluded from the steps above.

The following experiment is listed to verify the performances of the present invention, but the scope of the present invention is not limited thereto.

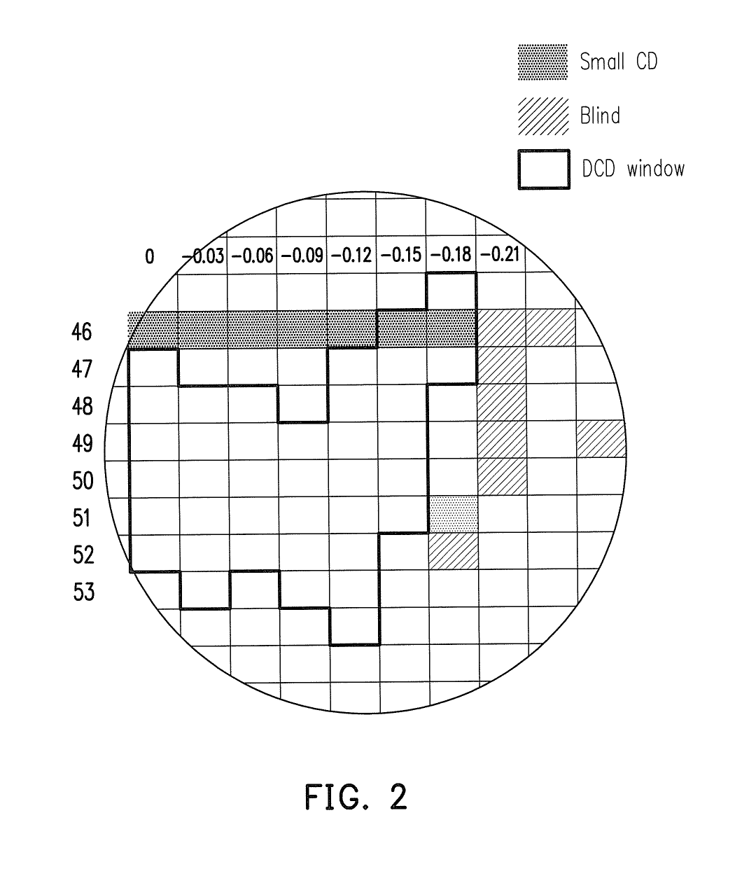

First, a whole wafer is detected by current KLA inspection for obtaining a contact window, and then the contact window along with DCD (developing critical dimension) window is illustrated in FIG. 2.

It is noted that most defects (i.e., dotted regions and hatched regions in FIG. 2) are outside the DCD window.

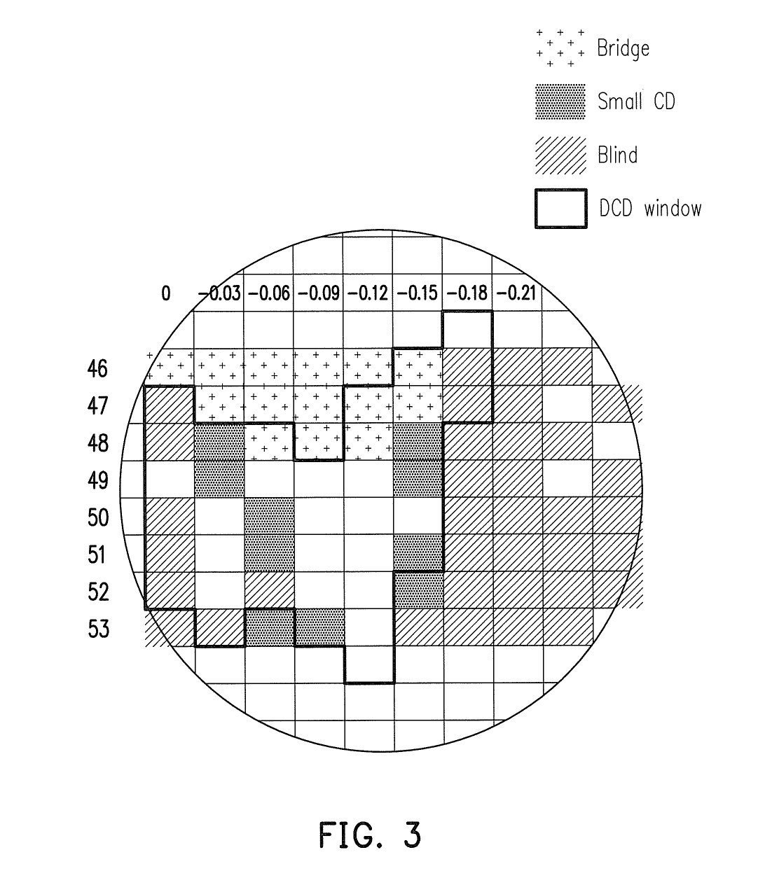

However, when performing the inspection method in the embodiment of the invention on the same wafer, every contact of each dies in the whole wafer may be observed by means of CDU (critical dimension uniformity) Map. In other words, it may be detected in a single die of up to thousands of contact windows. FIG. 3 shows the DCD widows and a contact window obtained by the inspection method in the embodiment of the invention. In FIG. 3, many defects such as the small contacts (i.e., dotted regions in FIG. 3) and the blind contacts (i.e., hatched regions in FIG. 3) are within the DCD window, and the bridge defects (i.e., the regions marked with crosses in FIG. 3) are also detected. Therefore, in comparison with FIG. 2, it may more accurately measure the contact window according to the inspection method in the embodiment of the invention.

In view of the foregoing, since the E-beam images of the contacts of the invention are readily available in the design database and may be aligned with the coordinates, the accurate defect information for all the contacts in the die or even the whole wafer may be obtained real-time or off-line, and the information may be rapidly compared with the database.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An inspection method for a contact by die to database, comprising:
obtaining raw images of a plurality of contacts in a wafer;
decoding positions of the raw images of the contacts to obtain a decoded graphic file;
aligning the graphic file on a design database of a chip;
performing an image extraction on the raw images to obtain a plurality of image contours of the contacts; and
measuring a difference in a critical dimension between the image contours of the contacts and a plurality of corresponding contacts in the design database.

2. The inspection method for the contact by die to database as claimed in claim 1, wherein the contact further comprises a via or a poly plug in the die.

3. The inspection method for the contact by die to database as claimed in claim 1, wherein the difference comprises at least one of numerical differences in radius, size, and circular area of the contact.

4. The inspection method for the contact by die to database as claimed in claim 1, further comprising determining a defect type of the contacts based on the difference.

5. The inspection method for the contact by die to database as claimed in claim 4, wherein the defect type comprises a small contact, a bridge contact, or a blind contact.

6. The inspection method for the contact by die to database as claimed in claim 1, wherein before obtaining the raw images, the method further comprises:
selecting a plurality of inspection areas that the contacts are located to be inspected in the wafer; and
resetting coordinates of the inspection areas to minimize overlapped portions of the areas.

7. The inspection method for the contact by die to database as claimed in claim 6, wherein the method of selecting the inspection areas comprises setting an area having the critical dimension (CD) lower than a predetermined value in the design database to be the inspection area.

8. The inspection method for the contact by die to database as claimed in claim 6, wherein the method of selecting the inspection areas comprises setting an area having the contact with a size over or under a predetermined value to be the inspection area according to a design rule.

9. The inspection method for the contact by die to database as claimed in claim 6, wherein the method of selecting the inspection areas comprises selecting the inspection areas according to a result of a wafer defect inspection previously performed.

10. The inspection method for the contact by die to database as claimed in claim 1, wherein the method of obtaining the raw images comprises an E-beam inspection or an E-beam SEM review tool.

11. The inspection method for the contact by die to database as claimed in claim 10, wherein an apparatus for executing the E-beam inspection comprises an E-beam inspection tool, a bright field inspection equipment with a light source having a wavelength of 150 nm to 800 nm, a dark field inspection equipment with a laser light source, or a scanning electron microscope review tool.

12. The inspection method for the contact by die to database as claimed in claim 1, wherein the method of obtaining the raw images further comprises decoding a metafile of the raw images and marking a position of the die and a defect coordinate position corresponding to a die corner.

13. The inspection method for the contact by die to database as claimed in claim 1, wherein the method of obtaining the raw images further comprises transferring the raw images into the die database according to the connection between KLA Klarf file and the raw images.

14. The inspection method for the contact by die to database as claimed in claim 1, wherein the method of obtaining the raw images further comprises decoding a filename of the raw images and marking a position of the die and a defect coordinate position corresponding to a die corner.

15. The inspection method for the contact by die to database as claimed in claim 1, wherein the method of obtaining the raw images comprises:
shooting a known die position and a defect coordinate position corresponding to a die corner; and
transferring the known die position and a corresponding image into a die database.

16. The inspection method for the contact by die to database as claimed in claim 1, wherein the design database comprises a GDSII file of a source design database, a GDSII file of a simulated post-optical proximity correction (post-OPC), or a design database converted from a simulated tool.

17. The inspection method for the contact by die to database as claimed in claim 1, wherein the method of obtaining the raw images of the contacts comprises obtaining the raw images of the contacts in selected regions in all the dies or the chips within the whole wafer.

18. The inspection method for the contact by die to database as claimed in claim 1, wherein the method of obtaining the raw images of the contacts comprises obtaining the raw images of the contacts in selected regions in a portion of the dies or the chips within the whole wafer.

19. The inspection method for the contact by die to database as claimed in claim 1, wherein before obtaining the raw images of the contacts, the method further comprises performing a die register to improve alignment performance.

20. The inspection method for the contact by die to database as claimed in claim 1, wherein before obtaining the raw images of the contacts, the method further comprises:
setting an identify position on to-be-shot positions or to-be-inspected coordinates in different dies to improve alignment performance, and
setting a virtual die corner on the to-be-shot positions or the to-be-inspected coordinates in different dies to improve alignment performance.
